(19) United States
(12) Patent Application Publication
(10) Pub. No.: US 2011/0087388 A1
(43) Pub. Date: Apr. 14, 2011

(54) AUTOMATIC DISPLAY OF APPROACH MINIMUMS

(75) Inventors: Gary S. Watson, Ada, MI (US); Blake R. Getson, Columbus, OH (US); Kevin Carney, Westerville, OH (US); David H. Sitter, Dublin, OH (US); Dennis Polischuk, Rockford, MI (US); Roger L. Powers, Reed City, MI (US); Eric R. Francis, Westerville, OH (US); Shawn M. Hyde, Grandview Heights, OH (US); Brian S. Zingg, Glendale, AZ (US)

(73) Assignee: L-3 COMMUNICATIONS AVIONICS SYSTEMS, INC., Grand Rapids, MI (US)

(21) Appl. No.: 12/904,352

(22) Filed: Oct. 14, 2010

Related U.S. Application Data
(60) Provisional application No. 61/251,471, filed on Oct. 14, 2009.

(51) Int. Cl. G06F 19/00; G06F 3/048

(52) U.S. Cl. 701/16; 715/780

(57) ABSTRACT

A system installed in an aircraft automatically retrieves and displays approach minimum data to the pilot, thereby relieving him or her of the burden of searching for the desired information. The display of the data may take the form of a complete or partial image of a published approach chart. In a variation, the system may both automatically retrieve and automatically enter the desired data into the flight plan, thereby relieving the pilot of both the searching and data-entry tasks. The system may include a database, a screen, a control, and a controller.

### CROSS-REFERENCE TO RELATED APPLICATIONS

This application claims priority to U.S. provisional application Ser. No. 61/251,471 filed Oct. 14, 2009, entitled “Automatic Display of Approach Minimums,” by the same inventors. The complete disclosure of this provisional application is hereby incorporated herein by reference.

### BACKGROUND OF THE INVENTION

The present invention relates to aircraft cockpit display systems, and more particularly to aircraft cockpit display systems used to enter and define flight plans, including information relating to an approach to an airport or runway.

Existing aircraft cockpit display systems enable pilots to enter information into one or more devices, such as, but not limited to, multi-function displays in order to, define a flight plan. Such flight plan information may include the series of waypoints that define the aircraft's intended path from a particular point of origin to a particular destination. The flight plan may further include the identification of an approach to a particular runway at the destination airport, or, in the case of a circle-to-land approach, an approach to the airport itself. A pilot may be able to enter a minimum approach altitude into the display device for storage as part of the flight plan. In order to do this, the pilot typically must consult a published approach chart, such as, but not limited to, those published by the Jeppesen company of Englewood, Colo. Consulting the chart may require the pilot to sift through a large binder of published charts. Alternatively, consulting the chart may require the pilot to switch the display device to a chart retrieval mode, manually enter data identifying the chart of interest, read the desired chart, write down or memorize the minimum altitude data, switch back to the flight planning mode, and then manually enter the minimum altitude data.

### SUMMARY OF THE INVENTION

According to its various embodiments, the present invention provides an improved system and method for electronic flight planning that reduces or eliminates the workload on the pilot during the selection and/or entry of data regarding approaches to runways. The system, in one embodiment, may automatically retrieve and display approach minimum data for the pilot, thereby relieving him or her of the burden of searching for the desired information. In another embodiment, the system may both automatically retrieve and automatically enter the desired data into the flight plan, thereby relieving the pilot of both the searching and data-entry tasks.

According to one embodiment, an aircraft cockpit display system is provided that includes a database, a screen, a control, and a controller. The database stores information identifying minimum altitudes for a plurality of approaches to airport runways. The control allows a pilot to manipulate information displayed on the screen. The controller communicates with the database, the screen, and the control. The controller also allows a pilot to use the control to select a specific approach for a specific airport and to enter a minimum altitude for the selected specific approach. The controller is adapted to retrieve from the database data indicating a value for the minimum altitude of the specific approach and to display a screenshot on the screen enabling a pilot to enter the value into a flight plan. The screenshot includes a display of the value retrieved from the database.

According to another embodiment, a method is provided for entering information into a flight plan using a cockpit display. The method includes providing on the display an option for entering a minimum altitude for an approach to a particular runway into the flight plan. The method also includes, in response to a user selecting the option for entering a minimum altitude, displaying on the display a value-entry field in which a user may input a minimum altitude. The method further includes automatically retrieving from memory a value corresponding to the minimum altitude and displaying the value on the display.

According to yet another embodiment, an aircraft cockpit display system is provided that includes a database, a screen, a control, and a controller. The database stores information from published sources identifying minimum altitudes for a plurality of approaches to airport runways. The control allows a pilot to manipulate information displayed on the screen. The controller communicates with the database, the screen, and the control. The controller further allows a pilot to use the control to select a specific approach for a specific airport and to enter a minimum altitude in a value-entry field on the screen for the selected specific approach. Means for displaying the approach minimum altitude retrieved from the database at substantially the same moment a value-entry field is shown on the display are also included.

According to other embodiments, the display of the minimum altitude value for a specific approach may take on the form of a complete, or partial, image of a published approach chart. The screen, control, and controller may be part of a multi-function display (MFD), a primary flight display (PFD), a center console display, an electronic flight bag, or other electronic device. The system may also be in communication with a PFD that is adapted to display the minimum altitude for the particular approach automatically when the approach becomes the active leg of the flight plan. The PFD may further be configured to provide a first annunciation to the pilot when the aircraft's current altitude falls within a threshold range of the minimum altitude, and a second annunciation when the aircraft's current altitude reaches the minimum altitude. The database may contain images of the minimum altitudes and the controller may be adapted to optically recognize the characters contained within these images to thereby enable the system to automatically enter the minimum altitude values in to the flight plan. The one or more controls used to select and enter a minimum altitude may take on the form of a dual concentric knob, or it may take on other forms. The approach may be an ILS, localizer, or any other type of approach to a specific runway, or it may be an approach to a specific airport, such as a circle-to-land approach. The minimum altitude may refer to the decision altitude (DA) for precision approaches, the minimum decision altitude (MDA) for non-precision approaches, or any other type of minimum altitude (hereinafter collectively referred to as a “minimum altitude”). The database may be partially or wholly embodied in a portable flash memory device, or its may be stored in non-portable memory integrated into the display system.

### BRIEF DESCRIPTION OF THE DRAWINGS

FIG. 1 is a block diagram of a cockpit display system according to a first embodiment;

FIG. 2 is a front, elevational view of an illustrative arrangement of cockpit displays, any one or more of which may incorporate one or more aspects of the inventive cockpit display system;

FIG. 3 is an illustrative layout of a flight planning menu that may be displayed on the screen of the cockpit display system;

FIG. 4 is a partial, illustrative screenshot that may be displayed on the cockpit display system and that includes a published approach chart with minimum altitude information, as well as a minimum altitude value-entry field;

FIG. 5 is another partial, illustrative screenshot that may be displayed on the cockpit system in lieu of the screenshot of FIG. 4;

FIG. 6 is a diagram of a dual concentric knob that may be used to enter altitude information into a flight plan;

FIGS. 7A-7D illustrate various forms of a data entry graphic that may be displayed on the cockpit display system for entering minimum altitude values;

FIGS. 8A-C illustrate various forms of another data entry graphic that may be displayed on the cockpit display system for entering minimum altitude values;

FIG. 9 is a flowchart of an automated display method for use in the cockpit display system;

FIG. 10 is a flowchart of an automated display and automated entry method for use in the cockpit display system; and

FIG. 11 is a partial screenshot of an altitude indicator that may be displayed on a primary flight display.

### DETAILED DESCRIPTION OF THE EMBODIMENTS

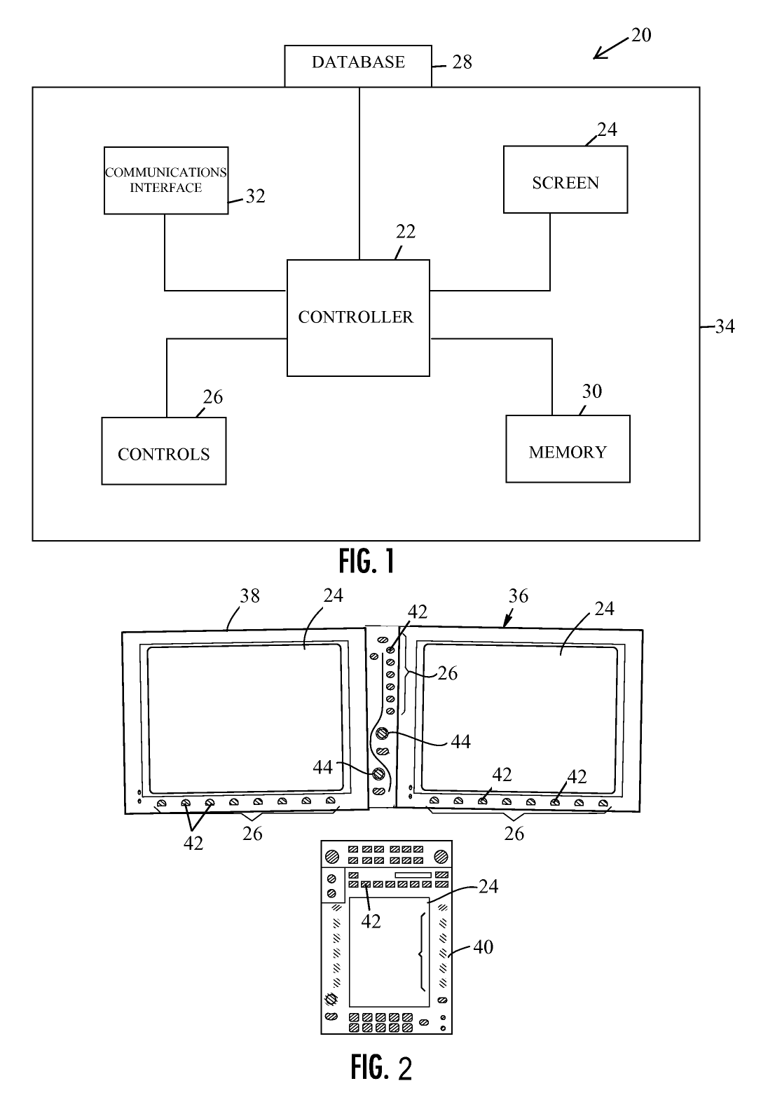

One embodiment of a cockpit display system 20 is illustrated in block diagram format in FIG. 1. Cockpit display system 20 is adapted to display information to a pilot on one or more screens 24 that are viewable to the pilot or co-pilot. Cockpit display system 20 may be integrated into the console of the aircraft such that it is not generally portable, or cockpit display system 20 may be a portable system that can be easily removed from the aircraft and carried with the pilot to locations outside of the aircraft. Such portable display systems include electronic flight bags, as well as other types of portable systems.

Display system 20 includes a controller 22, a screen 24, one or more controls 26, and a database 28. In some embodiments, display system 20 may also be in communication with a memory 30 and a communications interface 32. Display system 20 is housed within a display unit 34. Display unit 34 may be a multi-function display (MFD) 36, a primary flight display (PFD) 38, a center console display unit (CCD) 40, a combination of any two or more of these displays, or any other type of aircraft display or combination of aircraft displays. One example of an arrangement of a PFD 38, MFD 36, and CCD 40 is illustrated in FIG. 2. In the example illustrated in FIG. 2, display unit 34 may be embodied in MFD 36, PFD 38, and/or CCD 40. For purposes of the following discussion, it will be assumed that display unit 34 is incorporated into a multi-function display 36, although it will be understood by those skilled in the art that this is merely a selection that has been made for purposes of better illustrating the concepts discussed herein. As has been noted above, display unit 34 is not limited to MFD 36, but can include PFD 38, CCD 40, combination of these devices, as well as one or more other types of display devices.

Controller 22 of display system 20 may comprise one or more microprocessors, field programmable gate arrays, microcontrollers, systems on chip, and/or any other electronic circuitry capable of carrying out the functions described herein, as would be known to one of ordinary skill in the art. Controller 22 is in communication with screen 24 and is thereby able to control information that is displayed on screen 24. Controller 22 may include, or be in communication with, one or more separate processors, such as graphics processors, that manipulate the content displayed on screen 24. The communication between controller 22 and screen 24 may take place utilizing any suitable electrical connection or communication bus, as would be known to one skilled in the art.

Screen 24 may be a liquid crystal display (LCD), a plasma screen display, or any other type of display that is capable of displaying graphical information in response to information and/or instructions received from controller 22. As can be seen in the illustrative example in FIG. 2, MFD 36, PFD 38 and CCD 40 each include a screen 24.

Display unit 34 includes one or more controls 26 that allow a pilot to manipulate the controller 22 and to control the information that is displayed on screen 24. The number of controls 26, as well as the type of controls 26, may vary substantially. In some embodiments, controls 26 may comprise one or more buttons 42, such as those illustrated adjacent to the screens 24 of MFD 36 and PFD 38 of FIG. 2. Alternatively, or additionally, controls 26 may comprise one or more dual concentric knobs 44, such as, but not limited to dual concentric knobs 44 of MFD 36 and PFD 38 of FIG. 2. It will, of course, be understood by those skilled in the art that controls 26 can take on other forms, such as, but not limited to, line select keys, knobs, touch screen inputs, switches, and other types of devices for controlling the display unit 34, including the information displayed on screen 24 of display unit 34.

Memory 30 may include memory for storing the instructions necessary for controller 22 to carry out the algorithms described herein, as well as any additional algorithms that may be desirably performed by controller 22. Memory 30 may comprise random access memory (RAM), read only memory (ROM), flash memory, or one or more different types of portable electronic memory, such as disks, DVDs, CD-ROMs, etc., or any suitable combination of these types of memory devices. In addition to storing the programming followed by controller 22, memory 30 may also store sufficient data to identify one or more flight plans. Such flight plan data may include a series of waypoints connecting a point of origin to a final destination, along with the various data associated with the flight plan. As will be described in more detail below, a pilot may manipulate one or more of controls 26 in order to define a flight plan that is then stored in memory 30, or another memory in communication with controller 22. A pilot may also utilize controls 26 to edit or delete information that is associated with one or more flight plans. As will also be discussed in greater detail below, display system 20 is adapted to allow a pilot to more easily input into the flight plan information associated with approaches to airports, such as a minimum decision altitude (MDA) or a decision altitude (DA) associated with a selected approach.

Controller 22 may be in communication with one or more other cockpit display devices or avionics devices. Such communications may take place by communications interface 32. Communications interface 32 may be any suitable communication interface for connecting display unit 34 to one or more other avionics devices or systems. In one embodiment, communications interface 32 may be a conventional ARINC 429 interface. In other embodiments, communications interface 32 may take on other forms. Communications interface 32, regardless of its form, enables controller 22 to communicate with other avionic devices. Such communication enables display unit 34 to receive information from other devices, as well as to share information with other devices.

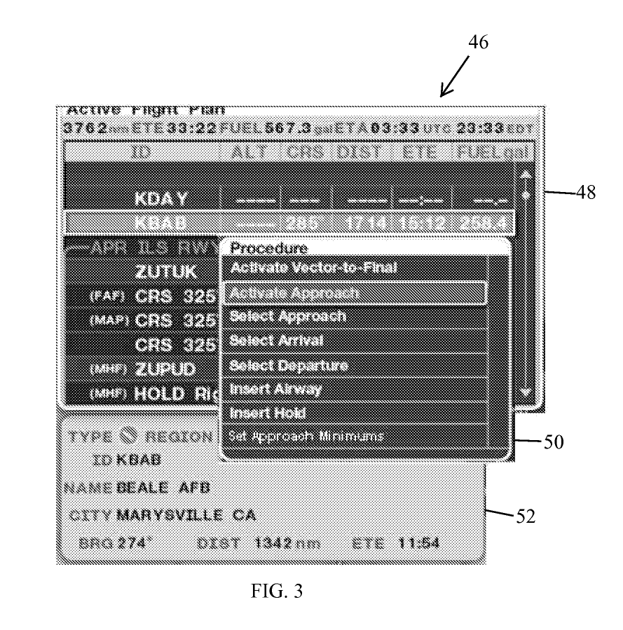

In one embodiment, controller 22 may be programmed to display, after suitable manipulation of controls 26, a flight planning graphic of the type shown in FIG. 3. Through the appropriate manipulation of controls 26, controller 22 is configured to cause screen 24 to display sufficient information on screen 24 to allow a pilot to edit and enter flight plan definitions. The graphical layout and organization of this information may take on a wide variety of forms, and the accompanying drawings are illustrative of but only a few examples of the layout, content, and form in which this information may be displayed. Therefore, the content and organization of the data illustrated in the attached drawings should not be interpreted as limiting of the manner, type, content, or arrangement of the flight information displayed on the one or more screens 24.

The graphic 46 of FIG. 3 includes an active flight plan window 48, a procedure window 50, and an information window 52. The active flight plan window 48 identifies a series of waypoints or other navigation aids that are part of the active flight plan. The active flight plan refers to the flight plan currently being followed by the aircraft. Once the pilot has brought up active flight plan window 48, the pilot is able to utilize one or more of controls 26, such as dual concentric knobs 44, to scroll through the list of navigation points and highlight a selected navigation point. In the example illustrated in FIG. 3, the airport identifier KBAB has been highlighted.

After a pilot selects the desired destination airport, such as KBAB in FIG. 3, controller 22 may be programmed to display a procedure window 50, such as that illustrated in FIG. 3. Procedure window 50 illustrates a variety of different procedures that may be performed with respect to the selected airport. In the example illustrated in FIG. 3, the procedure window 50 allows a pilot to activate a vector to final action, to activate an approach, to select an approach, to select an arrival, to select a departure, to insert an airway into a flight plan, to insert a hold into a flight plan, and to set approach minimums for a selected approach. The pilot is able to select from the various procedures illustrated in procedure window 50 by manipulating one or more of the appropriate controls 26. In one embodiment, a pilot can scroll down the list of procedure options in window 50 by rotating one of the two knobs on dual concentric knob 44. In other embodiments, a pilot is able to select a desired procedure from window 50 by pressing the appropriate button, or otherwise activating an appropriate control 26.

Information window 52 may appear on screen 24 in response to the selection of a particular waypoint, airport, or other navigation aid listed in active flight plan window 48. In the example shown in FIG. 3, information window 52 provides information about the airport with the identifier KBAB. As can be seen in FIG. 3, this airport corresponds to Beale Air Force Base in Marysville, Calif. Information window 52 provides relevant information about this airport with respect to the aircraft's current position, such as the bearing to the airport, its distance and the estimated time enroute (ETE).

Controller 22 is programmed in such a manner to cause screen 24 to display an interface for inputting an approach minimum altitude value in response to the pilot choosing the “set approach minimums” choice from the procedure window 50. That is, after a pilot scrolls down procedure window 50 to the “set approach minimums” option and uses the appropriate control 26 to select this option, controller 22 will display an interface on screen 24 that enables a pilot to enter a minimum altitude for the selected approach. The layout of the approach minimum interface can take on a wide variety of different forms.

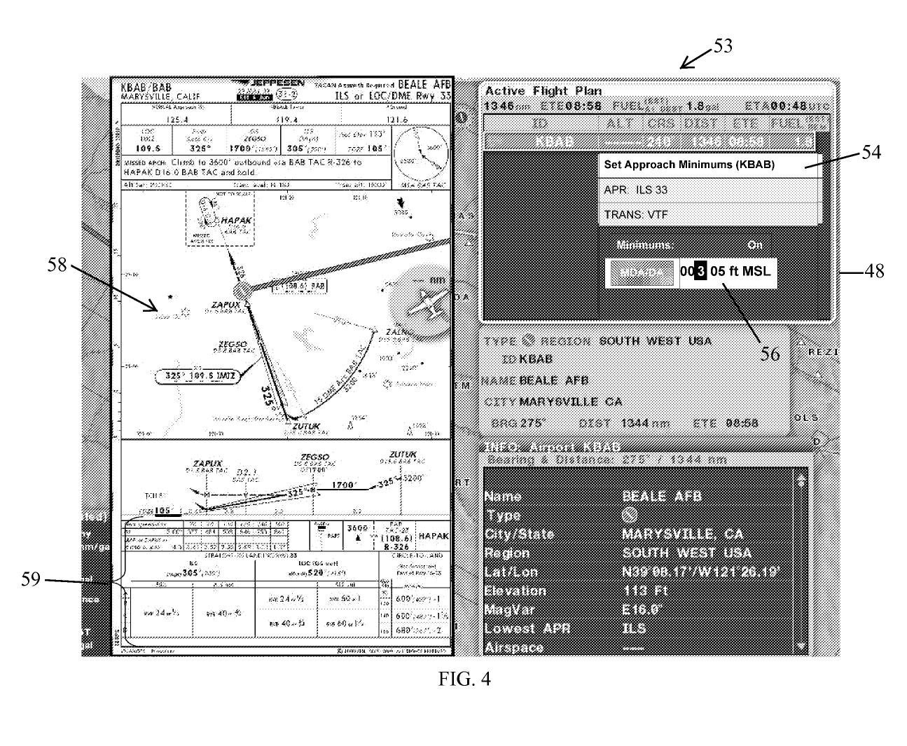

FIG. 4 illustrates a partial screen shot 53 that may be displayed on screen 24 by controller 22 in response to a pilot selecting the “set approach minimum” option from procedure window 50. Partial screen shot 53 of FIG. 4 includes active flight plan window 48 and an approach minimum setting window 54 inside of window 48. Approach minimum setting window 54 includes a value entry field 56 in which a pilot may input a minimum altitude corresponding to the selected approach. In order to assist the pilot in determining what value should be entered into the value entry field 56, controller 22 is configured to automatically display on screen 24 an approach chart 58, or a portion of an approach chart 58, that includes the correct minimum altitude for the selected approach.

In the example illustrated in FIG. 4, approach chart 58 is an approach chart published by the Jeppeson Company of Englewood, Colo. Approach charts 58 published by other organizations, such as the Federal Aviation Administration of the U.S. government, or other entities, may alternatively be wholly or partially displayed. Controller 22 is configured to automatically display chart 58 substantially at the same time that value entry field 56 is displayed on screen 24. While it is not necessary that approach chart 58 be displayed exactly at the same time that value entry field 56 is displayed, approach chart 58 or the relevant portion of it, should be displayed either before, or at, the moment when a pilot is able to enter data into value entry field 56. In the illustrated embodiment, both chart 58 and value entry field 56 are displayed simultaneously on the same screen 24, although in other embodiments chart 58, or a portion of it, may be displayed on another screen 24 separate from the screen showing field 56.

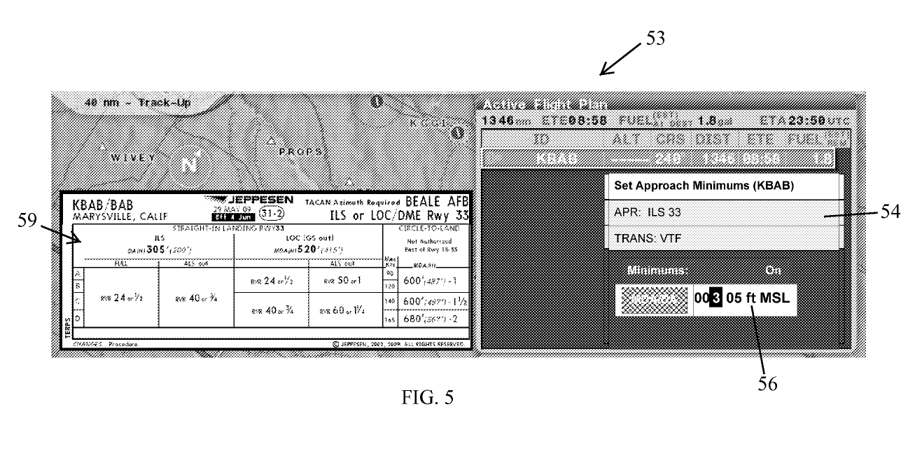

As can be seen in FIG. 4, approach chart 58 includes a landing minimums section 59 that identifies the various minimum heights for the different types of aircraft and types of approaches (e.g. ILS, localizer, circle-to-land, etc.). For example, as can be seen more clearly in FIG. 5, minimums section 59 identifies a decision altitude (DA) of 305 feet for an ILS approach to runway 33. It also identifies a minimum decision altitude (MDA) of 520 feet for a localizer approach to runway 33. Still further, it identifies an MDA of 600 feet for a circle-to-land approach for category A and B aircraft, and an MDA of 680 feet for a circle-to-land approach for category C and D aircraft. In the arbitrary example of FIG. 4, an ILS approach for runway 33 has been selected. A pilot would therefore enter 305 feet into value entry field 56 using one or more suitable controls 26.

The purpose of displaying approach chart 58 is to assist the pilot in determining what values should be entered into value entry field 56. By automatically displaying approach chart 58 while value entry field 56 is displayed, the pilot does not need to manually flip through a stack of approach charts to find the chart corresponding to the selected approach, nor does the pilot need to manipulate any controls 26 in order to electronically retrieve the chart 58 corresponding to the selected approach. Rather, controller 22 is programmed to automatically retrieve approach chart 58 from database 28 and display it on screen 24 when value entry field 56 is displayed thereon.

Database 28 may be stored in memory 30, or it may be stored in a separate memory. As noted earlier, memory 30 may be physically integrated into display unit 34, either wholly or partially, and may comprise one or more different types of electronic memory. Database 28, in one embodiment, may be incorporated into a portable flash memory device, such as a secure data (SD) card, a compact flash card, or other type of portable media. If database 28 is stored in a portable flash memory device, display unit 34 may include a port for receiving the portable flash memory device. Alternatively, the flash memory device may be plugged into another physical structure that is in communication with display unit 34. Regardless of the physical storage medium for database 28, it is electronically accessible to controller 22. The contents of database 28 may be obtained from multiple sources, such as, but not limited to, the Jeppesen Company of Englewood, Colo.

Controller 22 is programmed to display within approach minimum setting window 54 an identification of the selected approach. Controller 22 displays this identification by retrieving from memory 30 the stored approach that has been previously selected by the pilot or other user. The manner in which the approach may have been previously selected can vary. In one embodiment, the approach may have been selected by choosing the “select approach” option from the procedure window 50 (FIG. 3). Alternative methods for selecting an approach may also be utilized. Regardless of the particular method by which an approach is or was selected, controller 22 has access to the memory that stores the data identifying the selected approach that has been selected by the pilot. In response to the pilot selecting the “set approach minimum” option from procedure window 50, controller 22 retrieves from memory the information identifying the approach selected by the pilot. Controller 22 then uses this information to automatically retrieve from database 28 the approach chart corresponding to the selected approach. Controller 22 accomplishes this by automatically searching the charts stored in database 28, which are electronically stored in a manner that allows them to be retrieved by airport IDs and particular runways, and/or other manners.

After retrieving from database 28 the electronic data identifying the approach chart corresponding to the selected approach, controller 22 causes screen 24 to display either the complete approach chart 58 (FIG. 4) or the minimums section 59 of the chart that identifies the minimum altitudes (see FIG. 5). The display of approach chart 58, or section 59, enables the pilot to read from approach chart 58, or section 59, the published minimum altitudes for the selected approach. In one embodiment, as will be discussed more below, the pilot must then utilize one or more controls 26 to input the appropriate minimum value into value entry field 56.

In another embodiment, as will also be discussed more below, controller 22 is programmed to automatically input the corresponding minimum approach value into value entry field 56. Such automatic entry may be performed simultaneously with the display of chart 58, or chart section 59, and allow the pilot an opportunity to verify—using the chart information—that the correct value has been entered.

In still another embodiment, system 20 may be configured such that the “set approach minimums” option in procedure window 50 need not appear (FIG. 3). Instead, controller 22 may be programmed to automatically retrieve the appropriate minimum altitude for a selected approach after a pilot selects a particular approach using the “select approach” option window 50 without requiring any further action by the pilot. In such an embodiment, controller 22 may display the automatically entered minimum at any desired location on screen 24 to provide the pilot with this information. One or more controls 26 may be used to edit this value.

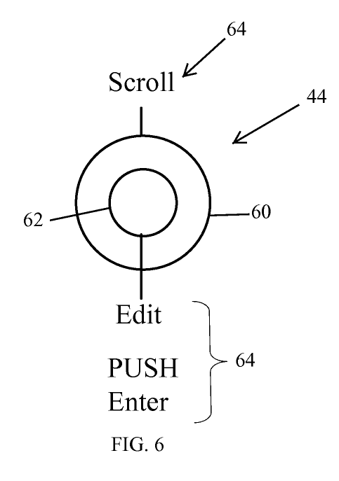

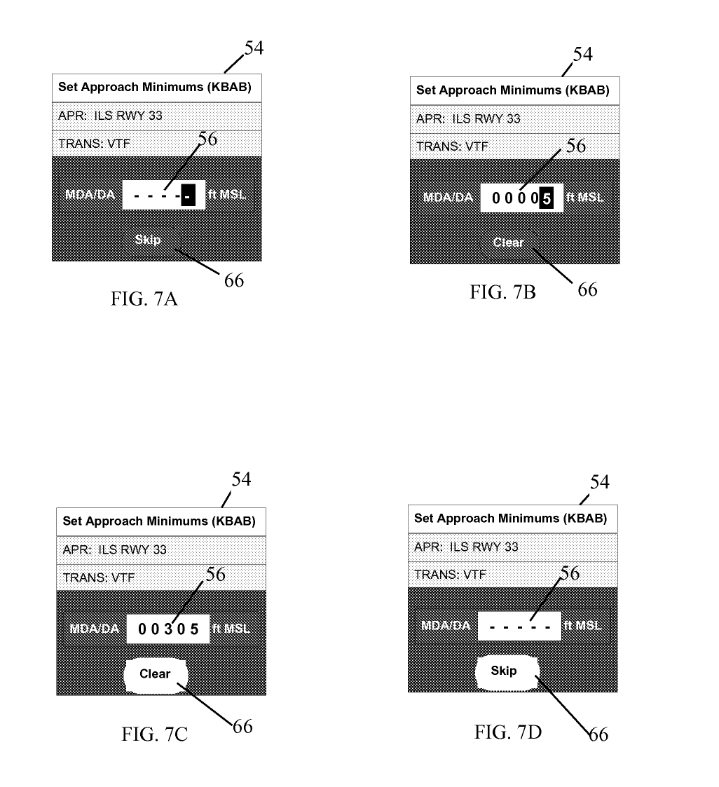

As has been described above, the manner in which a pilot may manipulate one or more controls 26 to input a minimum altitude may be varied. FIG. 6 illustrates one example of a dual concentric knob 44 that may be used to input values into display unit 34, such as a minimum altitude. Dual concentric knob 44 includes an outer knob 60 and an inner knob 62. A plurality of labels 64 may be positioned on screen 24 at a location adjacent to dual concentric knob 44. Labels 64 identify the function of each of the knobs 60 and 62. The labels may change depending upon the context of display unit 34. That is, depending on the information being displayed on screen 24, the functions of the dual concentric knob 60 and 62 may vary. FIG. 6 illustrates one example of the functions of knobs 60 and 62 while value entry field 56 is displayed. In the example shown in FIG. 6, rotation of outer knob 60 will cause controller 22 to scroll through a menu of options within a particular window. Rotation of inner knob 62 will change the values within a selected option in that particular menu. Pushing of inner knob 62 will cause the value entered in a particular data field to be entered into the system. These functions are described in more detail below with respect to FIGS. 7A-D and 8A-C.

FIGS. 7A-7D illustrate one example of a manner in which information may be input into approach minimum setting window 54. Approach minimum setting window 54 in FIGS. 7A-7D includes value entry field 56 and a function field 66. Value entry field 56 serves as the location where a pilot is able to enter a minimum altitude for a particular approach. Function field 66 allows the pilot to select between various functions. In the example of FIGS. 7A-7D, function field 66 allows the pilot to skip the inputting of a value into value entry field 56, or, alternatively, to clear any value that may have been input into value entry field 56. The manner in which the dual concentric knob 44 can be used to input and edit data in field 56 can be varied. The examples discussed herein are therefore only illustrative and not limiting.

By rotating outer knob 60, the pilot can toggle between value entry field 56 and, function field 66. Function field 66 changes between displaying a “clear” function (FIGS. 7B and 7C) and a “skip” function (FIGS. 7A and 7D), depending upon the choices made by the pilot using knobs 44 and the context. After a pilot has selected value entry field 56, rotation of inner knob 62 causes the value within value entry field 56 to change. In FIG. 7B, the value within value entry field 56 is changed to a 5. In FIG. 7C, the value within value entry field 56 is changed to 305. FIG. 7D illustrates the clearing function. That is, FIG. 7D illustrates what happens after the pilot has selected the clear function from field 66.

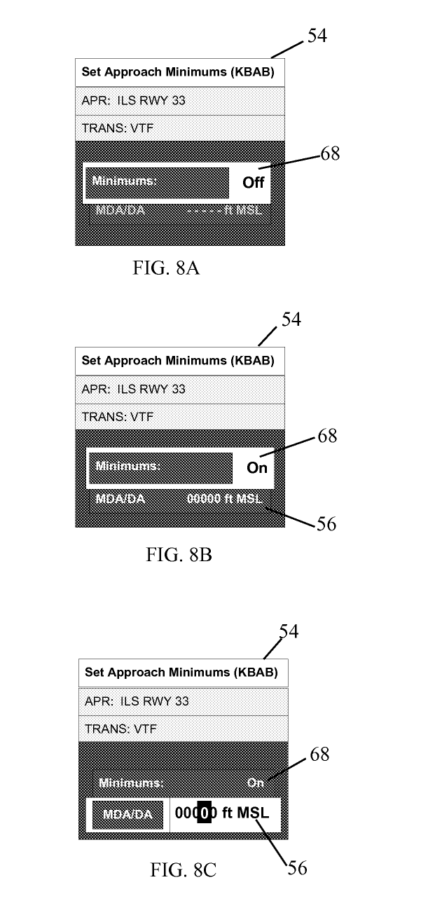

FIGS. 8A-8C illustrate another layout that may be used to set approach minimums using window 54. Approach minimum setting windows 54 of FIGS. 8A-8C provide the same function of allowing data to be entered into value entry field 56, but the particular layout has been changed with respect to FIGS. 7A-7D. As can be seen in FIGS. 8A-8C, window 54 includes an on/off field 68. The value contained within on/off field 68 can be changed by rotating one of inner knob 62 or outer knob 60. Such rotation will cause minimum altitude entry function to toggle between being turned on and turned off.

FIG. 8B illustrates an example of how controller 22 may change screen 24 in response to the minimums function being turned on. Specifically, once the minimums functions has been turned on, controller 22 may cause screen 24 to display value entry field 56 below on/off field 68. A pilot may then select the value entry field 56 using dual concentric knob 44 and enter the appropriate altitude using inner knob 62, outer knob 60, or a combination of both. After the appropriate altitude has been entered, the pilot may push inner knob 62 to enter the value, and/or alternatively, scroll back to on/off field 68 to turn the minimum function off if the pilot wants to cancel the minimum function. As will be discussed in greater detail below, the minimums function refers to the automatic display of the minimum altitude during the aircraft's approach, as well as annunciations regarding the aircraft's current altitude relative to the minimum altitude.

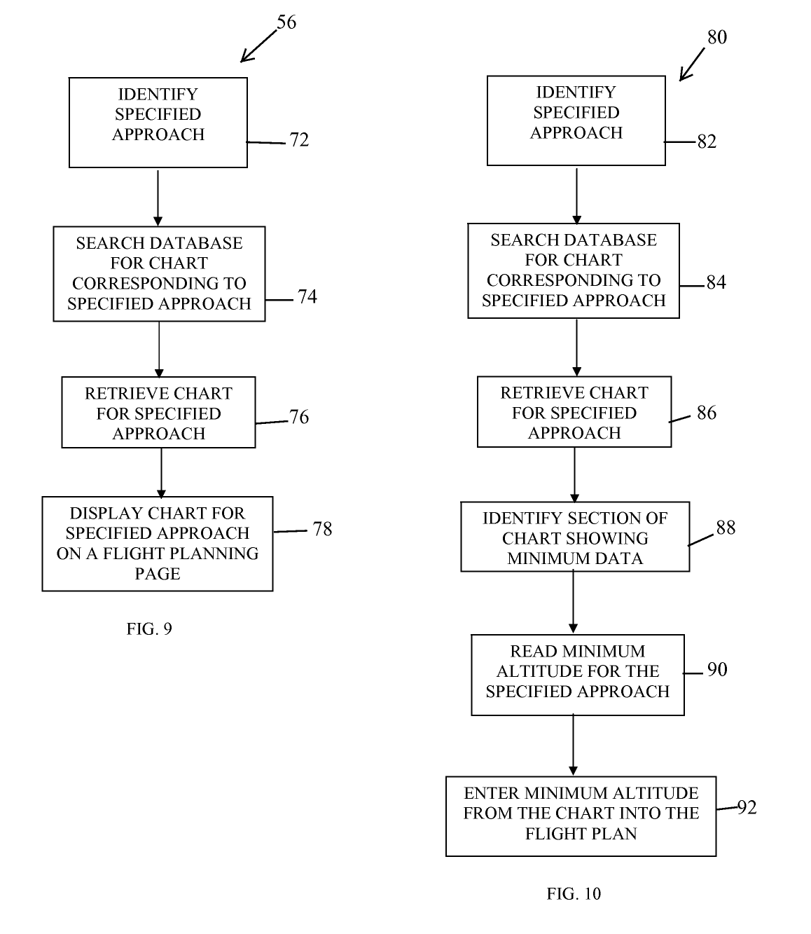

FIG. 9 illustrates in block diagram form a first method 70 that may be followed by controller 22 in response to a pilot indicating, via controls 26, that he or she would like to input a minimum altitude into a selected flight plan. First method 70 is followed by controller 22. At a first step 72, controller 22 identifies the specific approach of interest from the flight plan. Controller 22 identifies the specific approach by consulting memory 30, which contains the data for the flight plan being edited by the pilot. Once the approach has been identified by controller 22, controller 22 searches database 28 for the approach chart 58 corresponding to the specified approach. This is performed at step 74. At step 76, controller 22 retrieves the approach chart 58 corresponding to the specified approach. At step 78, controller 22 displays the retrieved chart 58, or the portion 59 thereof, on screen 24. The display of the approach chart 58, or a portion 59, is done during the time value entry field 56 is also shown on screen 24, thereby facilitating the pilot's entry of a specific value in field 56. After the minimum value is entered into field 56 either automatically by controller 22 or manually by the pilot, the controller saves the value as part of the flight plan and uses it for alerting the pilot during the actual approach, as discussed more below.

FIG. 10 illustrates a second method 80 of facilitating the entry of approach minimum altitudes that may be followed by controller 22. In a first step 82, controller 22 identifies the specified approach for the flight plan currently being edited or created. Step 82 may be identical to step 72. In a second step 84, controller 22 searches database 28 for the approach chart 58, that specifically corresponds to the specified approach. At a next step 86, controller 22 retrieves the approach chart 58 or section 59 corresponding to the specified approach.

For both steps 76 and 86, the manner in which controller 22 retrieves the corresponding approach chart 58 or section 59 for the selected approach may depend upon the file format in which approach charts 58 are stored within database 58. In one embodiment, approach chart 58 are stored as image files, such as, but not limited to, bitmaps or raster graphics files. When stored in such a manner, each approach chart 58 may include at least one searchable data field that enables controller 22 to search through the individual approach charts 58 until the one corresponding to the selected approach is located. Such data fields may include airport identification letters, airport names, or other suitable information that may be used to identify a particular airport or runway. If controller 22 is configured to display only portion 59 of approach chart 58, controller 22 retrieves the appropriate approach chart 58 and displays only section 59 of the chart. Controller 22 may be programmed to identify section 59 by way of metadata that accompanies the image files in database 28. Such metadata may identify which section of the bitmap file corresponds to the approach minimums data. One suitable file format for storing images of approach charts with metadata identified sections of those charts can be found in commonly assigned, co-pending, PCT Application No. PCT/US2008/061386, filed Apr. 24, 2008, the complete disclosure of which is incorporated herein by reference. Other types of file formats may also be used, either with or without metadata identifying sections of the charts corresponding to the approach minimum data. In some embodiments, such file formats may include vector graphics format, as well as other formats.

At a fourth step 88, controller 22 identifies from the retrieved approach chart information identifying the specific minimum altitude for the specified approach. At step 90 controller 22 reads the minimum altitude from the retrieved approach chart. In method 80, controller 22 is programmed to automatically identify and extract the minimum approach altitude for the selected approach from database 28 and enter it into the flight plan without requiring the pilot to manually enter the minimum altitude value into display unit 34. In this embodiment, controller 22 retrieves from database 28 the data for the approach chart 58 corresponding to the selected approach and thereafter electronically reads the correct minimum information contained within approach chart 58. If chart 58 is stored as a vector graphics file, or similar type of file, the minimum data may be read directly from database 28. On the other hand, if approach chart 58 is stored as an image file, controller 22 may be programmed to utilize conventional optical character recognition software to read the value on approach chart 58 corresponding to the minimum decision altitude (MDA) or decision altitude (DA) of the selected approach.

Regardless of the specific file format of approach chart 58, controller 22 automatically enters this value into the stored flight plan at step 92. Regardless of the chart file format, once the minimum is read, the value may be automatically stored as part of the flight plan data by controller 22. In such an embodiment, the pilot is not required to utilize any of the controls 26 to input a value into value entry field 56. Rather, controller 22 automatically inputs this value. Such automatic inputting may be accomplished without displaying approach chart 58, or it may happen in conjunction with the display of approach chart 58. The value that is automatically input by controller 22 may also be displayed in value entry field 56 so that the pilot may, if desired, confirm that the value automatically entered therein matches that shown on approach chart 58. Controller 22 may also be programmed to allow the pilot to alter the automatically entered value if changes are desired. Second method 80 therefore automates the process of entering the approach minimum altitude into a flight plan, while first method 70 requires the pilot to manipulate one or more controls 26 in order to enter the appropriate value for the approach minimum altitude. Variations to both methods 70 and 80 may be made.

Display unit 34 may be configured to provide an annunciation to the pilot during the aircraft's approach to a runway or airport. Such annunciation indicates the aircraft altitude relative to the minimum altitude. In one embodiment, the annunciation may occur at two different times. At a first moment, the annunciation may occur when the aircraft's current altitude changes to within a threshold range of the minimum altitude. At a second moment, the annunciation may occur when the aircraft's current altitude reaches the minimum altitude. Such annunciation may take on any of a variety of suitable formats. In one embodiment, the annunciations may be made on primary flight display 38 and may include an aural indication, such as a beeping sound, or other sound alerting the pilot that the aircraft is either approaching the minimum altitude, or is at the minimum altitude. In carrying out this annunciation, controller 22 may be in communication with a navigation system that determines the current altitude of the aircraft. Alternatively, controller 22 may forward the minimum altitude information to another controller, via communications interface 32, and that other controller, or controllers, may be in communication with the aircraft's navigation system. In one embodiment, the first annunciation may be made when the aircraft's current altitude is 250 feet above the corresponding approach minimum altitude. The second annunciation may be made when the aircraft's current altitude equals the corresponding minimum approach altitude. Variations to the specific parameters at which the annunciations are made can be implemented. Further, the number of annunciations may be increased above two, or decreased below two. Visual annunciation may also be made.

Controller 22 of display unit 34 is also, in at least one embodiment, programmed to cause an alert to be issued to the pilot when performing a GPS approach with vertical guidance where the integrity of the detected GPS positioning signals is degraded. Such an alert may notify the pilot and allow him or her to edit the minimum altitude from display unit 34. Controller 22 carries out this alerting function via communication with a GPS unit onboard the aircraft and/or any other avionic computing resources that monitor the integrity of the data being provided by the GPS unit. The manner for determining the GPS integrity may be conventional.

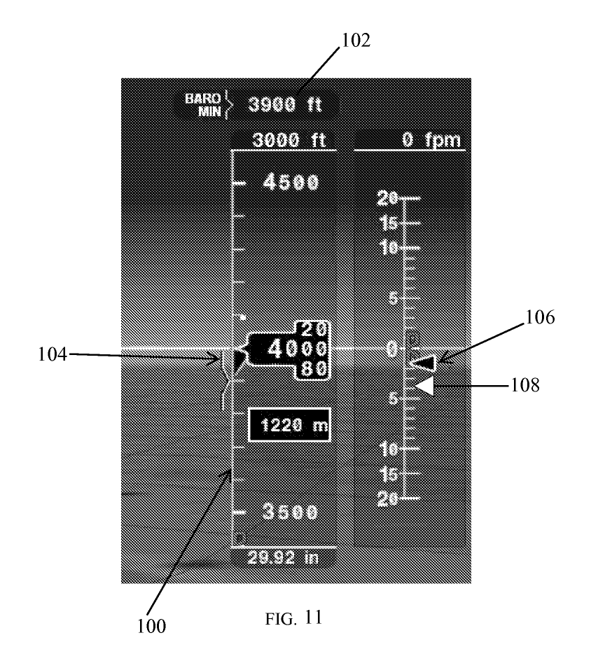

FIG. 11 illustrates an altitude scale 100 that may be displayed on primary flight display 38, multi-function display 36, or some other display unit 34. Altitude scale 100 provides a visual indication to the pilot of the aircraft's current altitude. Further, as can be seen in FIG. 11, cockpit display system 20 may be configured to include a minimum indicator 102. Minimum indicator 102 provides a visual indication of the minimum altitude that was input into value entry field 56 during method 70, 80, or a variant thereof. Minimum decision indicator 102 may be displayed on screen 24 while the aircraft is on the final approach to the runway, or prior to the aircraft being on the final approach to the runway. Altitude scale 100 further includes a minimum altitude bug 104 positioned on altitude scale 100 at the location corresponding to the minimum altitude entered into value entry field 56. FIG. 11 also includes a vertical speed indicator 106. Vertical speed indicator 106 may include a required vertical speed bug 108 that provides an indication of the vertical speed required to get the aircraft to the minimum altitude.

Changes and modifications in the specifically described embodiments may be carried out without departing from the principles of the present invention, which is intended to be limited only by the scope of the appended claims, as interpreted according to the principles of patent law including the doctrine of equivalents.

What is claimed is:

1. An aircraft cockpit display system comprising:
a database adapted to store information identifying minimum altitudes for a plurality of approaches to airport runways;
a screen;
a control adapted to allow a pilot to manipulate information displayed on said screen; and
a controller in communication with said database, said screen, and said control, said controller adapted to allow a pilot to use said control to select a specific approach for a specific airport and to enter a minimum altitude for said selected specific approach for said specific airport, said controller adapted to retrieve from said database data indicating a value for said minimum altitude for said specific approach for said specific airport, said controller further adapted to display a screenshot on said screen enabling a pilot to enter said value into a flight plan wherein said screenshot includes a display of said value.

2. The system of claim 1 wherein said screenshot includes a display of at least a partial image of an approach chart.

3. The system of claim 2 wherein screen, said control, and said controller are all part of a multi-function display.

4. The system of claim 3 further including a primary flight display, said primary flight display adapted to display said value when an aircraft containing said cockpit display system is flying along said selected specific approach.

5. The system of claim 3 wherein said primary flight display is further adapted to provide a first annunciation to the pilot when the aircraft's current altitude falls within a threshold range of said value, and a second annunciation when the aircraft's current altitude reaches said value.

6. The system of claim 1 wherein said display of said value includes an image of said value stored in an image file format.

7. The system of claim 6 further including an optical character recognition algorithm adapted to determine said value from said image of said value and to automatically insert said value into said flight plan

8. The system of claim 2 wherein said screenshot includes a first area for displaying said value retrieved from said database and a second area for displaying a value-entry field, said value-entry field allowing a pilot to use said control to enter said value into said flight plan, said value and said value-entry field being displayed simultaneously.

9. The system of claim 8 wherein said control includes a dual concentric knob having an outer knob and an inner knob, said controller adapted to display different numerals in said value-entry field in response to rotation of at least one of said outer and inner knobs.

10. The system of claim 1 wherein screen, said control, and said controller are all part of a electronic flight bag.

11. A method of entering information into a flight plan using a cockpit display, said method comprising:
providing on the display an option for entering a minimum altitude for an approach to a particular runway into the flight plan;
in response to a user selecting said option for entering a minimum altitude, displaying on said display a value-entry field in which a user may input a minimum altitude; and
automatically retrieving from memory a value corresponding to said minimum altitude and displaying said value on said display.

12. The method of claim 11 wherein said displaying of said value is done on said display at a location different from the display of said value-entry field.

13. The method of claim 11 including simultaneously displaying said value and said value-entry field on said display.

14. The method of claim 11 further including displaying at least a portion of a published approach chart on said display, said portion of the published approach chart including said value.

15. The method of claim 14 wherein said portion of the published approach chart excludes any map section of the chart.

16. The method of claim 11 further including automatically entering said value into said flight plan.

17. The method of claim 11 further including providing a dual concentric knob having first and second knobs, and configuring said knob to allow a user to change values in said value-entry field upon rotation of at least one of the first and second knobs.

18. The method of claim 11 further including automatically removing said value from said display after a user enters said value into the flight plan via said value-entry field.

19. An aircraft cockpit display system comprising:
a database adapted to store information from published sources identifying minimum altitudes for a plurality of approaches to airport runways;
a screen;
a control adapted to allow a pilot to manipulate information displayed on said screen; and
a controller in communication with said database, said screen, and said control, said controller adapted to allow a pilot to use said control to select a specific approach for a specific airport and to enter a minimum altitude in a value-entry field on said screen for said selected specific approach; and
means for displaying from the database an approach minimum altitude value for the specific approach substantially at the moment a value-entry field is shown on said display.

20. The system of claim 19 further including means for automatically entering the approach minimum altitude into the flight plan without requiring the user to enter the value into the value-entry field.

21. The system of claim 19 wherein said database is at least partially stored on a portable flash memory device.
